(19) United States
(12) Patent Application Publication
(10) Pub. No.: US 2005/0154941 A1
(43) Pub. Date: Jul. 14, 2005

(54) Memory indication apparatus and method in a portable terminal

(75) Inventors: Young-Ran Lee, Gyeongsangbuk-do (KR); Hyun-Seok Kim, Gyeongsangbuk-do (KR); Dong-Joon Park, Gyeongsangbuk-do (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/001,323

(22) Filed: Dec. 2, 2004

(30) Foreign Application Priority Data
Jan. 9, 2004 (KR) 2004-1432

(51) Int. Cl. G08B 21/00

(52) U.S. Cl. 714/42; 439/64; 340/686.4; 340/5.8; 711/115; 340/654; 348/222.1

(57) ABSTRACT

A memory indication apparatus and method in a portable terminal is provided. Upon insertion of a memory, a user is notified of the insertion of the memory, and upon ejection of the memory, the user is notified of the ejection of the memory. A user is also notified of an authorization result.

### PRIORITY

This application claims the benefit under 35 U.S.C. § 119(a) of an application entitled “Memory Indication Method in a Portable Terminal” filed in the Korean Intellectual Property Office on Jan. 9, 2004 and assigned Serial No. 2004-1432, the entire contents of which are incorporated herein by reference.

### BACKGROUND OF THE INVENTION

1. Field of the Invention

The present invention relates generally to a memory in a portable terminal. In particular, the present invention relates to a method of indicating the insertion or ejection of a memory in a portable terminal, authenticating an inserted memory, and indicating the authentication result.

2. Description of the Related Art

With the increasing use of portable terminals, composite portable terminals are being developed which provide multiple functions as well as voice communications to satisfy users' demands. Also, the development of wireless networks, the rapid evolution of the wireless networks, and the proliferation of premium terminals have driven diverse and dynamic provisioning of contents. In view of the demands for a large volume of content under a changing environment, memory and uses for data communications have become an issue to service provides and users.

To meet the demand for a large volume of content, a detachable external memory has recently been adopted in addition to an internal memory in a portable terminal. However, when the external memory is ejected, the user may not recognize the ejection and attempt to use the external memory because the portable terminal does not notify the user of the insertion or ejection of the terminal memory. Even if another user's (i.e. unauthorized) external memory is inserted into the portable terminal, the user cannot detect the switch.

### SUMMARY OF THE INVENTION

An object of the present invention is to substantially solve at least the above problems and/or disadvantages and to provide at least the advantages below. Accordingly, an object of the present invention is to provide an apparatus and method of indicating the insertion or ejection of a memory in a portable memory.

Another object of the present invention is to provide an apparatus and method of indicating whether a memory inserted into a portable terminal belongs to the user of the portable terminal or to another user through authentication of the memory.

The above objects are achieved by providing a memory indication apparatus and method.

According to one aspect of the present invention, upon insertion of a memory, a user is notified of the insertion of the memory, and upon ejection of the memory, the user is notified of the insertion of the memory.

According to another aspect of the present invention, upon insertion of a memory, it is determined whether the memory belongs to a user of the portable terminal. If the memory belongs to the user, the user is notified that the memory is authorized. Upon ejection of the memory, the user is notified of the ejection of the memory.

According to a further aspect of the present invention, upon insertion of a memory, the memory is authenticated. If the memory belongs to a user of the portable terminal, the user is notified that the memory is authorized. If the memory does not belong to the user, the user is notified that the memory is unauthorized. Upon ejection of the memory, the user is notified of the ejection of the memory.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to an embodiment of the present invention;

FIG. 2 is a flowchart illustrating the insertion or ejection of a memory in the portable terminal according to the embodiment of the present invention;

FIG. 3 is a flowchart illustrating a memory authentication operation in the portable terminal according to the embodiment of the present invention;

FIGS. 4A to 4D illustrate messages indicating the insertion and ejection of the memory of the portable terminal's user and an unauthorized memory belonging to another user in the operation illustrated in FIG. 2; and

FIG. 5 illustrates lighting indicating the insertion or ejection of a memory in the operation illustrated in FIG. 2

### DETAILED DESCRIPTION OF THE PREFERRED EMBODIMENT

An embodiment of the present invention will be described herein below with reference to the accompanying drawings. In the following description, well-known functions or constructions are not described in detail for conciseness.

Examples for an apparatus and method of indicating the insertion and ejection of an external memory in a portable terminal, an apparatus and method of indicating that an inserted external memory belongs to the user of the portable terminal, and a method of indicating that the inserted external memory is an unauthorized memory are provided. It should be obvious to those skilled in the art that the embodiment of the present invention can be implemented without the examples shown or with modifications to the present invention.

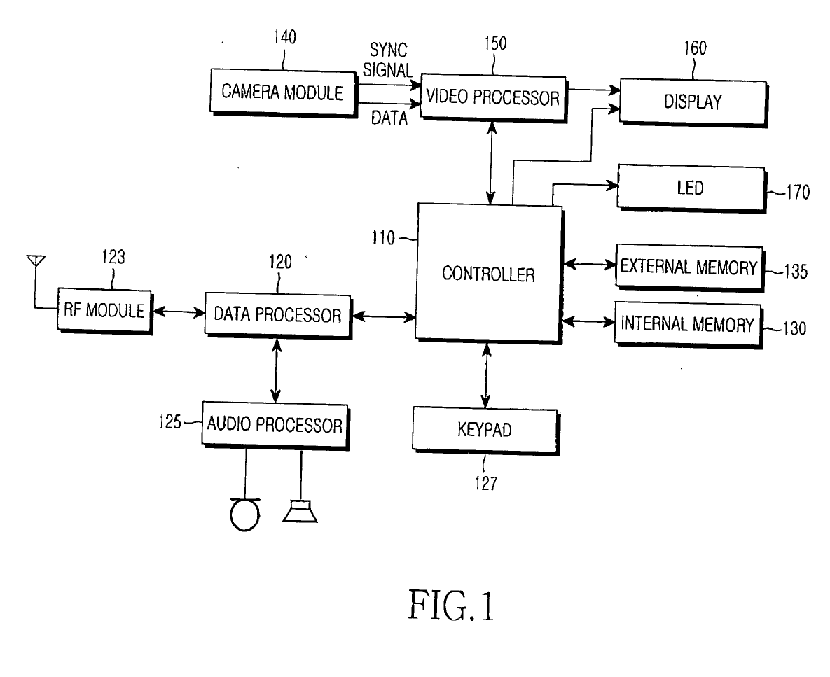

FIG. 1 is a block diagram of a portable terminal equipped with a camera according to an embodiment of the present invention.

Referring to FIG. 1, a Radio Frequency (RF) module 123 implements the radio communication functionality of the portable terminal. The RF module 123 includes an RF transmitter (not shown) for upconverting and amplifying the frequency of a transmission signal, and an RF receiver (not shown) for low-noise-amplifying a received signal and downconverting its frequency. A data processor 120 is provided with a transmitter for encoding and modulating the transmission signal and a receiver for demodulating and decoding the received signal. That is, the data processor 120 may be configured to have a MODEM and a CODEC. The CODEC includes a data CODEC for processing packet data and an audio CODEC for processing an audio signal like voice. An audio processor 125 reproduces the audio signal received from the voice CODEC of the data processor 120, or transmits an audio signal generated from a microphone to the audio CODEC.

An internal memory 130 can have a program memory and a data memory built in the portable terminal. The program memory may store programs for controlling conventional typical operations of the portable terminal, and programs for indicating the insertion and ejection of an external memory 135 and indicating the insertion of an unauthorized memory in the portable terminal according to the embodiment of the present invention. The data memory temporarily stores data generated during execution of the programs. The external memory 135 can be inserted into and ejected from the portable terminal. It stores various data such as MP3 music data, video data, and photo albums. When the external memory 135 is inserted into the portable terminal, the user can read data from or store data in the external memory 135.

A controller 110 controls the portable terminal. The controller 110 may incorporate the data processor 120 thereinto. According to the embodiment of the present invention, when the external memory 135 is inserted, the controller 110 notifies the user of the insertion of the external memory 135. If it determines that the inserted external memory 135 is the user's, the controller 110 notifies the user of the insertion of the user's external memory 135. If it determines that the inserted external memory is not the user's, the controller 110 notifies the user of the insertion of an unauthorized external memory.

A camera module 140 is provided with a camera sensor for capturing video data and converting the captured optical signal to an electrical signal, and a signal processor for converting the analog video signal received from the camera sensor to digital data. The camera sensor is assumed to be a Charge Coupled Device (CCD) sensor, and the signal processor can be implemented as a Digital Signal Processor (DSP). The camera sensor and the signal processor can be incorporated into a single device or separately configured.

A video processor 150 generates display data to display a video signal received from the camera module 140. The video processor 150 processes the video signal frame by frame and outputs the vide frame data according to the characteristics and size of a display 160. The video processor 150 has a video CODEC for compressing the video frame data in a predetermined method or recovering the compressed video frame data to the original video frame data. The video CODEC can be a Joint Picture Experts Group (JPEG) CODEC, a Moving Picture Experts Group 4 (MPEG4) CODEC, or a Wavelet CODEC. The video processor 150 is assumed to support On Screen Display (OSD) functionality. It outputs OSD data according to the size of the screen under the control of the controller 110.

The display 160 displays the video signal received from the video processor 150 and user data received from the controller 110. The display 160 can be a Liquid Crystal Display (LCD). In this case, the display 160 may include an LCD controller, a memory for storing video data, and an LCD device. If the LCD is implemented as a touch screen, it may function as a keypad. Also, the display 160 displays icons and messages indicating the insertion and ejection of the external memory 135. A keypad 127 includes keys for inputting digits and characters and function keys for invoking functions. A Light Emitting Diode (LED) 170 indicates the insertion or ejection of the external memory 135 according to an embodiment of the present invention.

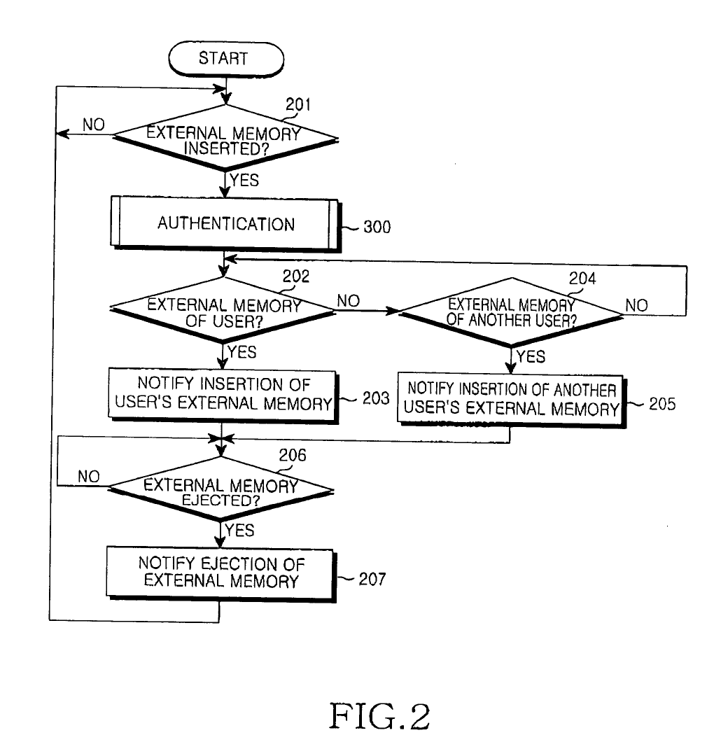

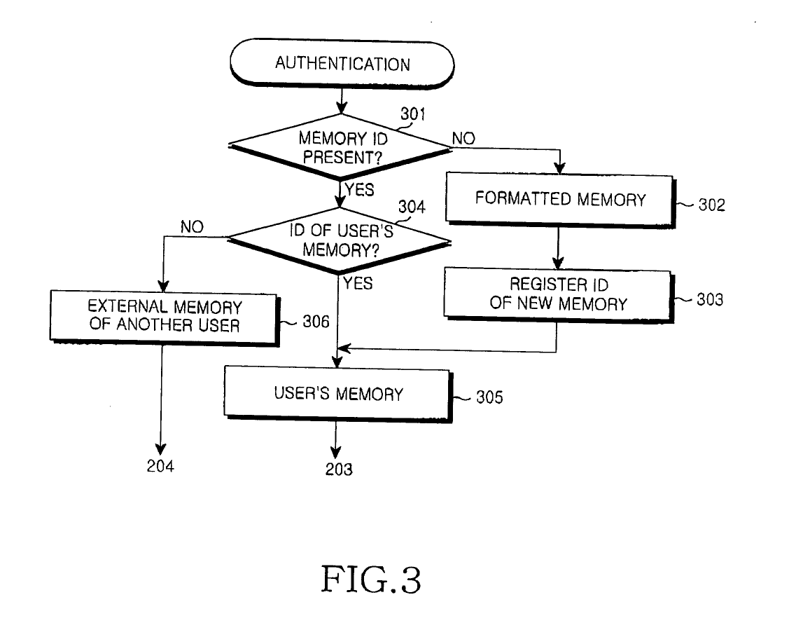

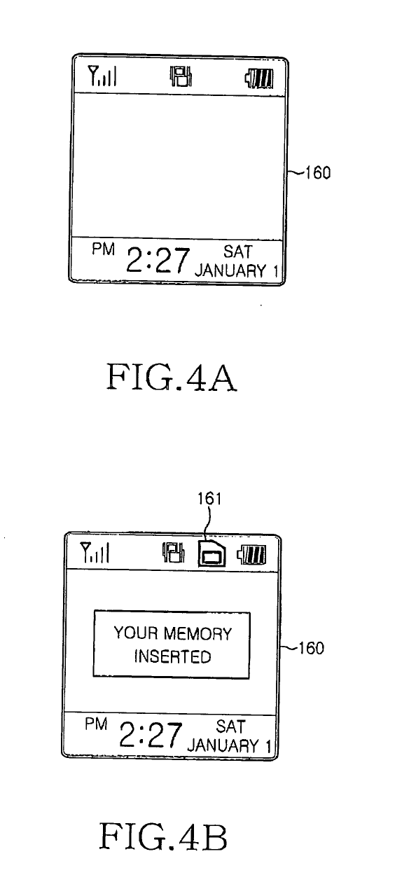

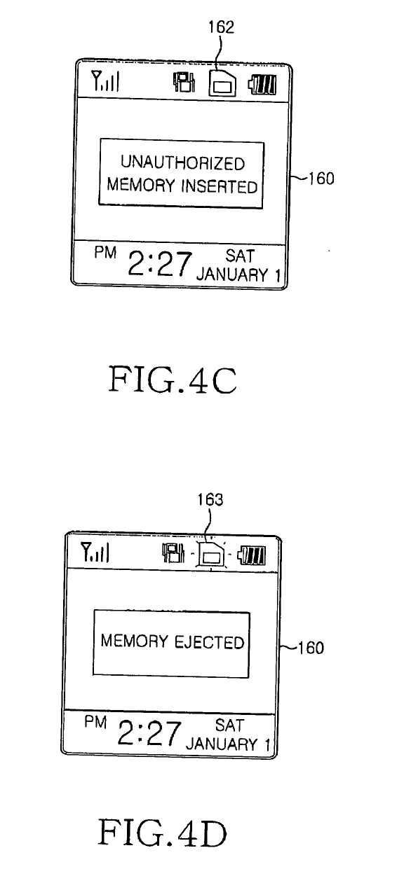

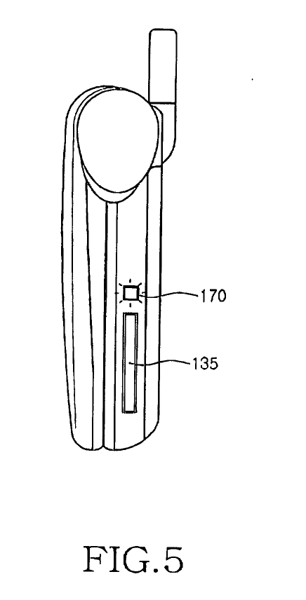

FIG. 2 is a flowchart illustrating an operation for indicating the insertion or ejection of a memory in the portable terminal according to the embodiment of the present invention, and FIG. 3 is a flowchart illustrating an authentication operation for an inserted external memory in the procedure of FIG. 2. FIG. 4A illustrates a display indicating an absence of the external memory, FIG. 4B illustrates a display indicating the insertion of the user's external memory, FIG. 4C illustrates a display indicating the insertion of an unauthorized external memory, and FIG. 4D illustrates a display indicating the ejection of the user's external memory or an unauthorized external memory. FIG. 5 illustrates lighting of the LED indicating the insertion or ejection of the external memory in the procedure of FIG. 2.

The embodiment of the present invention will now be described with reference to FIGS. 1 to 5.

Referring to FIG. 2, when a memory is inserted into the portable terminal in the absence of the external memory 135 as illustrated in FIG. 4A, the controller 110 detects the insertion of the memory in step 201 and determines whether the inserted memory belongs to the user of the portable terminal in step 300. In the display illustrated in FIG. 4A, an icon may be displayed to indicate the ejection of the memory. The memory authentication of step 300 will be described in detail with reference to FIG. 3. Referring to FIG. 3, the controller 110 determines whether a unique ID is set in the memory in step 301. In the absence of the unique ID, the controller 110 determines that the memory is a formatted empty memory in step 302 and registers the formatted memory as one of the user's memories by setting the unique ID of the user stored in the memory 160 in the formatted memory in step 303. The user may register a sequence number identifying the new memory as well. Because the user can have a plurality of memories through steps 302 and 303, the user enters sequence numbers identifying the memories, so that the controller 110 determines whether the inserted memory belongs to the user and, if it does, checks the sequence number of the memory, and correspondingly notifies the user of the insertion of the memory. The user can use titles, digits, or icons as the sequence numbers of the memories.

In the presence of a unique ID in the inserted memory, the controller 110 compares the ID of the inserted memory with that of the user's memory in step 304. If they are identical, the controller 110 determines that the inserted memory belongs to the user in step 305. Then, the controller 100 can check the sequence number of the inserted memory.

On the contrary, if the ID of the inserted memory is different from that of the user in step 304, the controller 110 determines that the inserted memory is an unauthorized memory in step 306.

Referring to FIG. 2, determining that the inserted memory belongs to the user in steps 202 and 305, the controller 110 notifies the user of the insertion of the external memory 135 by displaying an icon 161 on the display 160, as illustrated in FIG. 4B, in step 203. The icon is in a different shape or color in order to distinguish it from an icon indicating the insertion of an unauthorized memory. Or the controller 110 may display a notification message indicating the insertion of the external memory 135. Along with the notification message, the controller 110 may output a voice message. Also, the controller 110 may output an alarm to indicate the insertion of the external memory 135. The controller 110 can illuminate the LED 170 in a predetermined color as illustrated in FIG. 5 to indicate the insertion of the external memory 135. After indicating the insertion of the external memory 135, the controller 110 may disclose to the user what the memory is by displaying its sequence number as a title, a digit, or an icon.

If the inserted memory is an unauthorized memory in steps 204 and 306, the controller 110 notifies the user that the inserted memory is an unauthorized memory in step 205. As illustrated in FIG. 4C, the controller 110 displays an icon 162 indicating the insertion of the unauthorized memory on the display 160 in a different shape or color from that of the icon indicating the insertion of the external memory 135 in step 205. The controller 110 may display a notification message indicating the insertion of the unauthorized memory. It also alerts the user to the insertion of the unauthorized memory by a voice message as well. In addition, the controller 110 can output an alarm to indicate the insertion of the unauthorized memory. Also, the controller 110 may illuminate the LED 170 in a predetermined color to indicate the insertion of the unauthorized memory. When the memory is ejected after step 203 or step 205, the controller 110 detects the ejection of the memory 206 and notifies the user of the ejection of the memory in step 207. As illustrated in FIG. 4D, the controller 110 turns on and off or flashes the icon 163 for a predetermined time to alert the user of the ejection of the memory and, the predetermined time later, clears the icon 163 to transition to the state illustrated in FIG. 4A. Alternatively, upon the ejection of the memory, the controller 110 directly clears the icon 163 to thereby transition to the state illustrated in FIG. 4A. Here, the icon 163 may be displayed in a different shape and color from those of the icon 163 illustrated in FIGS. 4A to 4D. The controller 110 can also output an alarm to indicate the ejection of the memory. In addition, the controller 110 may turn on and off or flash the LED 170 for a predetermined time to indicate the ejection of the memory.

If, after the insertion of the external memory 135, data is moved from the internal memory 130 to the external memory 135 or data is stored in the external memory, that is, during operating the external memory 135, the controller 110 may indicate that the external memory 135 is in use by displaying an icon, a text message, and a voice message alone or in combination, thereby preventing the ejection of the external memory 135 while in use. Despite the indication, if the user ejects the external memory 135 during the memory operation, a warning sound or a warning message can be output.

In accordance with the embodiment of the present invention as described above, a user can be conveniently informed of the presence or absence of a memory by an indication of the insertion or ejection of the memory in a portable terminal.

Furthermore, when the memory is inserted, it is authenticated and the authentication result is indicated. Therefore, in case of insertion of an unauthorized memory, the user is immediately alerted to the insertion of another user's memory.

While the state of the memory 135 is indicated on the internal display 160 on the inner surface of the folder of the portable terminal in the embodiment of the present invention, it can be further contemplated that the insertion or ejection of the external memory 135 is displayed on an external display as well as the internal display 160 when the portable terminal is provided with the external display. Also, the portable terminal may be provided with a menu for setting and releasing the function of indicating the insertion or ejection of the external memory 135. The memory indication can be made by selecting an icon type, an icon color, flashing or non-flashing of an icon, an alarm sound type, a message type, and a voice message type. The durations of icon flashing, message display, and alarm sound are set freely. The position of the LED 170 is not limited to that illustrated in FIG. 5. The LED 170 can be positioned at any location that the user easily recognizes. Also, an in-built LED of the portable terminal can be utilized without the need for separately procuring an additional LED. In the case of a portable terminal capable of 360-degree folder rotation by means of a rotation device, the rotation device can implement the LED function.

While the invention has been shown and described with reference to a certain preferred embodiment thereof, it should be understood by those skilled in the art that various changes in form and details may be made therein without departing from the spirit and scope of the invention as defined by the appended claims.

1. A memory indication method in a portable terminal, comprising the steps of:
notifying, upon insertion of a memory, a user of the insertion of the memory; and
notifying, upon ejection of the memory, the user of the ejection of the memory.

2. The memory indication method of claim 1, further comprising the step of notifying the user that the memory is in use during operation of the memory.

3. A memory indication method in a portable terminal, comprising the steps of:
determining, upon insertion of a memory, whether the memory belongs to a user of the portable terminal;
notifying the user that the memory is authorized, if the memory belongs to the user; and
notifying, upon ejection of the memory, the user of the ejection of the memory.

4. The memory indication method of claim 3, further comprising the step of notifying the user that the memory is unauthorized, if the memory does not belong to the user.

5. A memory indication method in a portable terminal, comprising the steps of:
authenticating a memory, upon insertion of the memory;
notifying a user of the portable terminal that the memory is authorized, if the memory belongs to the user, and notifying the user that the memory is unauthorized, if the memory does not belong to the user; and
notifying, upon ejection of the memory, the user of the ejection of the memory.

6. The memory indication method of claim 5, further comprising the step of notifying the user of the sequence number of the memory, if the memory is authorized.

7. The memory indication method of claim 5, wherein the authentication step comprises the steps of:
determining whether an identifier (ID) exists in the inserted memory;
determining whether the ID of the memory is identical to an ID of the user, if the inserted memory has the ID;
determining that the inserted memory belongs to the user, if the ID of the memory is identical to the ID of the user; and
determining that the inserted memory does not belong to the user, if the ID of the memory is different from the ID of the user.

8. The memory indication method of claim 7, further comprising the step of determining the sequence number of the memory when it is determined that the inserted memory is authorized.

9. The memory indication method of claim 5, further comprising the steps of:
determining that the inserted memory is a formatted memory, if the memory does not have the ID; and
registering the ID of the user in the inserted memory.

10. An apparatus adapted to perform memory indication for an external memory in a portable terminal, comprising:
a keypad adapted to enter commands;
an internal memory adapted to store programs;
a controller adapted to provide notification upon insertion of the external in the portable terminal, and notification upon ejection of the external memory from the portable terminal.

11. The apparatus of claim 10, wherein the controller is further adapted to provide an indication that the external memory is in use during operation of the external memory.

12. The apparatus of claim 10, wherein the controller is further adapted to determine whether the external memory belongs to a user of the portable terminal upon insertion of the external memory in the portable terminal, provide notification that the memory is authorized if the external memory belongs to the user, and provide an indication upon ejection of the external memory from the portable terminal.
